(19) United States
(12) Patent Application Publication
(10) Pub. No.: US 2024/0166886 A1
(43) Pub. Date: May 23, 2024

(54) ADDITIVE FOR WATER-BASED PAINT, WATER-BASED PAINT COMPOSITION, AND COATING LAYER

(71) Applicant: SHIN-ETSU CHEMICAL CO., LTD., Tokyo (JP)

(72) Inventor: Tomoyuki GOTO, Annaka-shi (JP)

(73) Assignee: SHIN-ETSU CHEMICAL CO., LTD., Tokyo (JP)

(21) Appl. No.: 17/768,673

(22) PCT Filed: Aug. 27, 2020
(86) PCT No.: PCT/JP2020/032432

§ 371 Date: Jan. 18, 2024

(30) Foreign Application Priority Data
Oct. 29, 2019 (JP) 2019-196496

(51) Int. Cl. C09D 5/16; C08G 77/46; C09D 7/65; C09D 133/04; C09D 175/04

(52) U.S. Cl. CPC C09D 5/1637; C08G 77/46; C09D 7/65; C09D 133/04; C09D 175/04

(57) ABSTRACT

The present invention is an additive for water-based paint, containing a siloxane-branched polyether-modified silicone shown by an average composition formula (1) R¹ₐR²_{b}R³_{c}SiO_{(4-a-b-c)/2} and having a weight-average molecular weight in a range of 500 to 100,000. In the formula (1), R¹ represents an alkyl group, an aryl group, an aralkyl group, or an organic group shown by a general formula (2) —CₘH₂ₘ—O—(C₂H₄O)_{d}(C₃H₆O)ₑR⁴. R² represents a group shown by a general formula (3)—CₘH₂ₘ—O— (C₂H₄O)_{f}(C₃H₆O)_{g}—R⁵; each R³ represents an organosiloxane shown by the following general formula (4). R⁴ represents a hydrocarbon group, or an organic group shown by R⁶—(CO)—. R⁵ represents a hydrogen atom, a hydrocarbon group, or an organic group shown by R⁶—(CO)—. R⁶ represents a hydrocarbon group. The siloxane branched polyether-modified silicone satisfies expressions (I), (II). Thus, this invention provides: a paint additive and a paint composition, particularly a water-based paint, with small environmental load and imparting excellent antifouling performance.

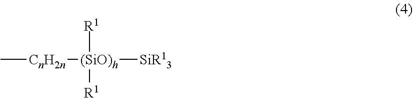

### TECHNICAL FIELD

The present invention relates to: an additive for water-based paint, the additive containing a siloxane-branched polyether-modified silicone; a water-based paint composition and a coating layer containing the additive for water-based paint; and, in further detail, a water-based paint composition and a coating layer with antifouling performance.

### BACKGROUND ART

In recent years, coatings with paints are performed so as to prevent dirt in various uses including: electric appliances, such as portable telephones, personal computers, televisions, and plasma displays; transportation equipment, such as motor vehicles and trains; and further various everyday necessities.

As a paint with excellent antifouling property, generally, a composition using an additive which contains fluorine in a molecule (Patent Document 1) is known. However, because the material is expensive, and from the standpoint of environmental issues, fluorine-free additives are required. From the same standpoint of environmental issues, water-based (water-soluble, water-dispersible) materials are also attracting attention as paints to be used.

As a fluorine-free paint additive, a polyether-modified silicone is widely used as paint additive for reasons of surface leveling property, defoaming property, etc. (Patent Document 2). However, a polyether-modified silicone imparting excellent antifouling performance is not known.

On the other hand, as a polyether-modified silicone for enhancing an emulsifying property for cosmetics, a siloxane-branched polyether-modified silicone produced by addition reaction of a polyoxyalkylene compound and a silicone compound to an organohydrogenpolysiloxane is known (Patent Document 3). However, the document does not disclose applications for paints at all.

### CITATION LIST

### Patent Literature

Patent Document 1: JP 2018-070683 A
Patent Document 2: JP 2013-166830 A
Patent Document 3: JP 2001-039819 A

### SUMMARY OF INVENTION

### Technical Problem

The present invention has been made in view of the circumstance. An object of the present invention is to provide: a paint additive and a paint composition, particularly a water-based paint, with small environmental load and imparting excellent antifouling performance.

### Solution to Problem

To achieve the object, the present invention provides an additive for water-based paint, comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000,

wherein in the formula (1) each R¹ is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4)

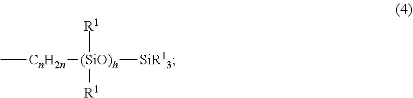

R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5, and wherein the siloxane-branched polyether-modified silicone satisfies the following expression (I) and the following expression (II),

5≤{(a total molecular weight of a (C₂H₄O)_{d} part in the general formula (2) and a(C₂H₄O)_{f} part in the general formula (3) incorporated in the siloxane-branched polyether-modified silicone)/(a molecular weight of the siloxane-branched polyether-modified silicone)}×20≤10, and expression (I):

{(a total molecular weight of a (C₃H₆O)ₑ part in the general formula (2) and a(C₃H₆O)_{g} part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}1.0. expression (II)

Such an additive for water-based paint can have little environmental load and impart excellent antifouling performance.

Moreover, the additive for water-based paint preferably further comprises a solvent.

Such an additive for water-based paint can have more excellent workability.

Further, the present invention provides a water-based paint composition comprising the additive for water-based paint.

Such a paint composition, particularly a water-based paint, contains the paint additive which successfully reduces environmental load and imparts excellent antifouling performance.

Furthermore, the inventive water-based paint composition preferably comprises a resin selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins.

Such various resins can be employed in the inventive water-based paint composition.

In this case, the resin is preferably a urethane resin or an acrylic resin.

These resins are preferable because of good compatibility with the additive for water-based paint containing the siloxane-branched polyether-modified silicone.

In addition, the inventive water-based paint composition is preferably used for antifouling paint.

The inventive water-based paint composition can exhibit excellent antifouling property without impairing various paint properties, such as defoaming property and leveling property.

Further, the present invention provides a coating layer formed from the water-based paint composition.

The inventive coating layer can be applied to various base materials, and exhibits excellent antifouling property.

### Advantageous Effects of Invention

The use of the inventive additive for water-based paint containing the siloxane-branched polyether-modified silicone makes it possible to provide the water-based paint composition and coating layer with small environmental load and excellent antifouling property.

### DESCRIPTION OF EMBODIMENTS

As described above, there have been demands for the development of a paint additive, as well as a paint composition and particularly a water-based paint, with small environmental load and imparting excellent antifouling performance.

The present inventor has diligently investigated to achieve the above object and consequently found that a siloxane-branched polyether-modified silicone imparts excellent antifouling performance to a paint, and completed the present invention.

Specifically, the present invention is an additive for water-based paint, comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000,

wherein in the formula (1) each R¹ is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4)

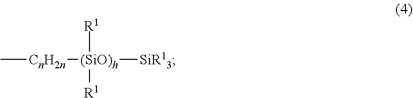

R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5, and wherein the siloxane-branched polyether-modified silicone satisfies the following expression (I), and the following expression (II),

5≤{(a total molecular weight of a (C₂H₄O)_{d} part in the general formula (2) and a (C₂H₄O)_{f} part in the general formula (3) incorporated in the siloxane-branched polyether-modified silicone)/(a molecular weight of the siloxane-branched polyether-modified silicone)}×20≤10, and expression (I):

{(a total molecular weight of a (C₃H₆O)ₑ part in the general formula (2) and a (C₃H₆O)_{g} part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}1.0. expression (II):

Hereinafter, the present invention will be described in detail. However, the present invention is not limited thereto.

### <Paint Additive>

The siloxane-branched polyether-modified silicone contained in the additive for water-based paint of the present invention is shown by an average composition formula (1) R¹ₐR²_{b}R³_{c}SiO_{(4-a-b-c)/2}. In the formula (1) each R¹ is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴. Each R² represents a group shown by a general formula (3) —CₘH₂ₘ—O—(C₂H₄O)_{f}(C₃H₆O)_{g}—R⁵. Each R³ represents an organosiloxane shown by the following general formula (4)

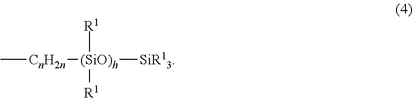

R⁴ represents a hydrocarbon group having 4 to 30 carbon atoms, or an organic group shown by R⁶—(CO)—. R⁵ represents a hydrogen atom, a hydrocarbon group having 1 to 30 carbon atoms, or an organic group shown by R⁶—(CO)—. R⁶ represents a hydrocarbon group having 1 to 30 carbon atoms. R¹ in the general formula (4) is the same as R¹ in the formula (1). “a”, “b”, and “c” respectively satisfy 1.0≤a≤2.5, 0.001≤b≤1.5, and 0.001≤c≤1.5. “d” and “e” respectively represent integers satisfying 0≤d≤50 and 0≤e≤50. “f” and “g” respectively represent integers satisfying 2≤f≤200, 0≤g≤200, and f+g being 3 to 200. “m” represents an integer satisfying 0≤m≤10. “h” represents an integer satisfying 0≤h≤500. “n” represents an integer satisfying 1≤n≤5.

Further, the siloxane-branched polyether-modified silicone satisfies the following expression (I),

5≤{(a total molecular weight of a (C₂H₄O)_{d} part in the general formula (2) and a (C₂H₄O) part in the general formula (3) incorporated in the siloxane-branched polyether-modified silicone)/(a molecular weight of the siloxane-branched polyether-modified silicone)}×20≤10; and the following expression (II), expression (I):

{(a total molecular weight of a (C₃H₆O) e part in the general formula (2) and a (C₃H₆O) g part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}≤1.0. expression (II):

R¹ in the formulae is an alkyl group, an aryl group, and an aralkyl group having 1 to 30 carbon atoms. R¹ is preferably an alkyl group, an aryl group, and an aralkyl group having 1 to 12 carbon atoms. R¹ is particularly preferably a methyl group, an ethyl group, a propyl group, a hexyl group, an octyl group, a dodecyl group, a phenyl group, and a 2-phenylpropyl group. Preferably, 80% or more of R¹'s are methyl groups.

Alternatively, R¹ may be an alkoxy group, an ester group, an alkenyl ether residue, or an alkenyl ester residue shown by the general formula (2) —CₘH₂ₘ—O—(C₂H₄O)_{d}(C₃H₆O)ₑ-R⁴. Herein R⁴ in the formula (2) is a monovalent hydrocarbon group having 4 to 30 carbon atoms, or an organic group shown by R⁶—(CO)—, and preferably a monovalent hydrocarbon group having 4 to 10 carbon atoms, or an organic group shown by R⁶—(CO)— because of availability. R⁶ is a hydrocarbon group having 1 to 30 carbon atoms, and preferably a hydrocarbon group having 1 to 10 carbon atoms because of availability.

“d”, “e” and “m” are respectively integers satisfying 0≤d≤50, 0≤e≤50, and 0≤m≤10, and preferably integers satisfying 0≤d≤30, 0≤e≤30, and 2≤m≤5 because of availability. Incidentally, when the polyoxyalkylene moiety in the formula (2) is composed of both ethyleneoxide units and propyleneoxide units, the polyoxyalkylene moiety may be any of a block polymer and a random polymer of these two units.

R² is a group shown by the general formula (3) —CₘH₂ₘ—O—(C₂H₄O)_{f}(C₃H₆O)_{g}—R⁵. Herein R⁵ in the formula (3) represents a hydrogen atom, a monovalent hydrocarbon group having 1 to 30 carbon atoms, or an organic group shown by R⁶—(CO)—, and preferably a hydrocarbon group having 1 to 10 carbon atoms, an organic group shown by R⁶—(CO)—, or a hydrogen atom because of availability. R⁶ is as defined above.

“f” and “g” are respectively integers satisfying 2≤f≤200 and 0≤g≤200, and preferably integers satisfying 2≤f≤50 and 0≤g≤50 because of availability. Further, f+g is an integer satisfying 3 to 200, and preferably an integer satisfying 5 to 100. If f+g is smaller than 3, the antifouling property lowers. If f+g is larger than 200, the synthesis is hindered. “m” is as defined above.

Incidentally, like the formula (2), when the polyoxyalkylene moiety in the formula (3) is composed of both ethyleneoxide units and propyleneoxide units, the polyoxyalkylene moiety may be any of a block polymer and a random polymer of these two units.

R³ is an organosiloxane shown by the following general formula (4).

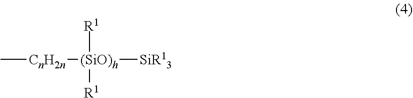

R¹ is as defined above. “h” is an integer satisfying 0≤h≤500, and preferably an integer satisfying 1≤h≤100. “n” is an integer satisfying 1≤n≤5, and preferably 2 because of availability. If “h” is larger than 500, the synthesis is hindered, and the compatibility with a resin is lowered as the water-based paint composition in some cases.

“a”, “b”, and “c” respectively satisfy 1.0≤a≤2.5, preferably 1.0≤a≤2.3, 0.001≤b≤1.5, preferably 0.05≤b≤1.0, and 0.001≤c≤1.5, preferably 0.01≤c≤1.0. If “a” and “b” deviates from the range, the compatibility is unstable as the water-based paint composition. Further, if “c” is below 0.001, the antifouling property as the water-based paint composition decreases, and if more than 1.5, the compatibility is unstable as the water-based paint composition.

Further, the siloxane-branched polyether-modified silicone shown by the formula (1) has a weight-average molecular weight of 500 to 100,000, preferably 1,000 to 80,000, and particularly preferably 1,500 to 40,000, in terms of polystyrene according to GPC. When the weight-average molecular weight is less than 500, the antifouling property lowers. When the weight-average molecular weight is 100,000 or more, the resulting silicone has such high viscosity that it is difficult to handle, and further the compatibility with a resin is lowered as the water-based paint composition in some cases.

The siloxane-branched polyether-modified silicone contained in the inventive additive for water-based paint can be obtained by a known method. For example, as described in Patent Document 3 (JP 2001-039819 A), the siloxane-branched polyether-modified silicone can be easily synthesized by subjecting an organohydrogenpolysiloxane to addition reaction with an alkenyl group-containing organosiloxane and an alkenyl group-containing polyoxyalkylene compound in the presence of a platinum or rhodium catalyst.

The siloxane-branched polyether-modified silicone shown by the formula (1) satisfies the following expression (I),

5≤{(a total molecular weight of a (C₂H₄O)_{d} part in the general formula (2) and a (C₂H₄O) part in the general formula (3) incorporated in the siloxane-branched polyether-modified silicone)/(a molecular weight of the siloxane-branched polyether-modified silicone)}×20≤ 10; and the following expression (II), expression (I):

{(a total molecular weight of a (C₃H₆O) e part in the general formula (2) and a (C₃H₆O) g part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}≤1.0. expression (II):

Further, the expression (I) is preferably

5.5≤{(a total molecular weight of a (C₂H₄O)_{d} part in the general formula (2) and a (C₂H₄O)_{f} part in the general formula (3) incorporated in the siloxane-branched polyether-modified silicone)/(a molecular weight of the siloxane-branched polyether-modified silicone)}×20≤9. expression (I):

The expression (II) is preferably

{(a total molecular weight of a (C₃H₆O) e part in the general formula (2) and a (C₃H₆O) g part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}≤0.5. expression (II):

If the value of the expression (I) is smaller than the range, the compatibility with other component(s) in the water-based paint composition is impaired, and this causes segregation or lowers the leveling property (forming spots). If the value is larger than the range, the antifouling property consequently lowers. Further, if the value of the expression (II) is larger than the range likewise, the compatibility with other component(s) in the water-based paint composition is impaired, and this causes segregation and lowers not only the leveling property (forming spots) but also lowers the antifouling property.

Moreover, the inventive additive for water-based paint may be the siloxane-branched polyether-modified silicone only, or may further contain a solvent in addition to the siloxane-branched polyether-modified silicone. When the inventive additive for water-based paint contains a solvent and is added to a water-based paint composition, homogenizing by stirring becomes easier. Further, the paint additive may contain other components as necessary.

As the solvent which may be blended to the inventive additive for water-based paint, for example, it is possible to use one explained in the description of the water-based paint composition described below. Preferable ones are water, propylene glycol methyl ether, propylene glycol ethyl ether, propylene glycol butyl ether, dipropylene glycol methyl ether, dipropylene glycol ethyl ether, propylene glycol monomethyl ether acetate, butyl acetate methyl ethyl ketone, methyl isobutyl ketone. Furthermore, when the inventive additive for water-based paint contains a solvent, for example, the water-based-paint additive may be a 10 to 90% solution of the siloxane-branched polyether-modified silicone, preferably 10 to 50% solution, and further preferably 15 to 30% solution.

### <Water-Based Paint Composition>

Furthermore, the present invention provides a water-based paint composition containing the additive for water-based paint. The water-based paint composition is used particularly for antifouling paint.

The addition amount of the siloxane-branched polyether-modified silicone (that is, the effective component contained in the inventive additive for water-based paint) is 0.01 to 10 parts by mass, preferably 0.1 to 5 parts by mass, of 100 parts by mass of the inventive water-based paint composition. With these ranges of the addition amount, dirt prevention corresponding to the addition amount is surely obtained, which is cost effective.

The inventive water-based paint composition preferably contains a resin. The resin is not particularly limited, and is selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins. The resin is preferably a urethane resin or an acrylic resin in view of the compatibility with the water-based-paint additive containing the siloxane-branched polyether-modified silicone.

The addition amount of the resin is 10 to 99.5 parts by mass, preferably 30 to 90 parts by mass, of 100 parts by mass of the inventive water-based paint composition. With the resin content being 10 parts by mass or more, there is no fear of decrease of mechanical strength.

The inventive water-based paint composition can be optionally blended with other well-known components in the industry as appropriate, such as a curing agent, a dilution solvent, a ultraviolet absorber, a polymerization initiator, a polymerization inhibitor, a neutralizing agent, a stabilizer (a light-resistant stabilizer, a weather-resistant stabilizer, a heat-resistant stabilizer), an antioxidant, a leveling agent, a defoaming agent, a viscosity adjuster, a precipitation-inhibitor, a pigment, a dye, a dispersant, an antistatic agent, an anti-fog agent, and a rubber. Isocyanate compounds usable in aqueous systems are useful as the curing agent. Examples thereof include aliphatic isocyanate (hexamethylene diisocyanate derivative, Bayhydur XP 2655 manufactured by Covestro AG), etc. The amount of the curing agent is not particularly limited, and may be 1 to 30 parts by mass, preferably 3 to 20 parts by mass, of 100 parts by mass of the inventive water-based paint composition.

Examples of the dilution solvent include water, alcohols, esters, aliphatic hydrocarbons, aromatic hydrocarbons, ketones. Preferable are water, propylene glycol methyl ether, propylene glycol ethyl ether, propylene glycol butyl ether, dipropylene glycol methyl ether, dipropylene glycol ethyl ether, propylene glycol monomethyl ether acetate, butyl acetate methyl ethyl ketone, and methyl isobutyl ketone. Particularly preferable are water, propylene glycol methyl ether, propylene glycol ethyl ether, propylene glycol butyl ether, dipropylene glycol methyl ether, and dipropylene glycol ethyl ether. The amount of the dilution solvent is not particularly limited, and may be 10 to 90 parts by mass, preferably 20 to 70 parts by mass, of 100 parts by mass of the inventive water-based paint composition.

The inventive water-based paint composition has a viscosity (25° C., B-type viscometer) of, for example, 1 to 10,000 mPa·s, preferably 10 to 5,000 mPa·s, in consideration of the coatability, film thickness, etc.

### <Coating Layer>

Further, the present invention relates to a coating layer using the water-based paint composition.

Various methods to be applied for typical paints are available as the coating method with the water-based paint composition for obtaining the inventive coating layer. Specifically, examples thereof include spray coating, spin coating, roll coating, curtain coating, brushing, electrostatic coating, anionic and cationic electrodeposition coating, dipping, etc. In addition, the curing method after coating is not particularly limited and examples thereof include (heat) curing particularly at 0 to 200° C., more preferably 40 to 180° C.

Moreover, examples of base materials to which the coating layer is applied (materials to be coated) include: plastics such as polystyrene resins, acrylic resins, acrylonitrile-styrene-butadiene resins (ABS), polypropylene, ethylene-propylene resins, polycarbonate resins, Noryl resins, nylon resins, polyester resins, and blends (alloys) of these resins with, for example, polyolefins, fillers, and reinforcement materials, such as glasses and carbon fibers; thermosetting resins, such as epoxy resins, unsaturated polyester resins, and urethane resins; inorganic materials, such as glasses, mortars, asbestos-cement slates, and rocks; metals, such as iron (and alloys), copper (and alloys), aluminum (and alloys), and magnesium (and alloys); combustible materials, such as papers and vinyl fabrics; etc.

### EXAMPLE

Hereinafter, the present invention will be specifically described with reference to Examples and Comparative Examples. However, the present invention is not limited thereto. Incidentally, in a case where multiple repeating units, each of which is shown in the parentheses, are included in the structural formulae described below, these units are arranged at random.

### Synthesis Example 1

In a reactor, 250 g of organohydrogensiloxane shown by the following structural formula (I), 43 g of organosiloxane shown by the following structural formula (i), and 150 g of isopropyl alcohol were mixed, and 0.05 g of isopropyl alcohol solution of 3% by mass chloroplatinic acid was added. This mixture was allowed to react at 80° C. for 4 hours.

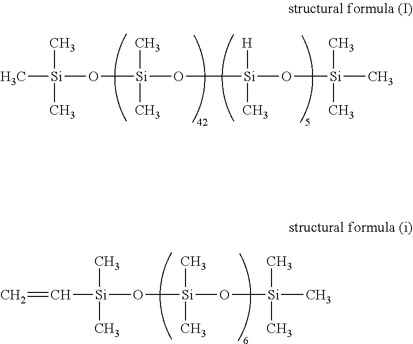

Then, 140 g of polyoxyalkylene compound of the following structural formula (a) was added, and the reaction was further continued for 3 hours.

CH₂═CHCH₂O(C₂H₄O)_{g}H structural formula (a)

After completion of the reaction, the obtained solution was heated under reduced pressure to distill the solvent to give a compound (A) of organopolysiloxane shown by the following structural formula in a yield of 95%.

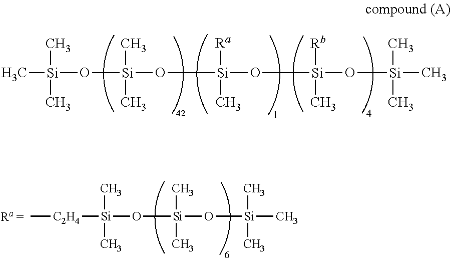

The obtained compound (A) had a value of 5.3 in the expression (I), a value of 0 in the expression (II), and a weight-average molecular weight of 6,000.

### Synthesis Example 2

A compound (B) of the following formula was obtained in a yield of 95% as in Synthesis Example 1, except that 250 g of organohydrogensiloxane shown by the following structural formula (II) was used instead of one in the structural formula (I) in Synthesis Example 1, the addition amount of organosiloxane of the structural formula (i) was changed to 62 g, and polyoxyalkylene compound of the structural formula (b) was used in place of one in the structural formula (a) and added in an amount of 160 g.

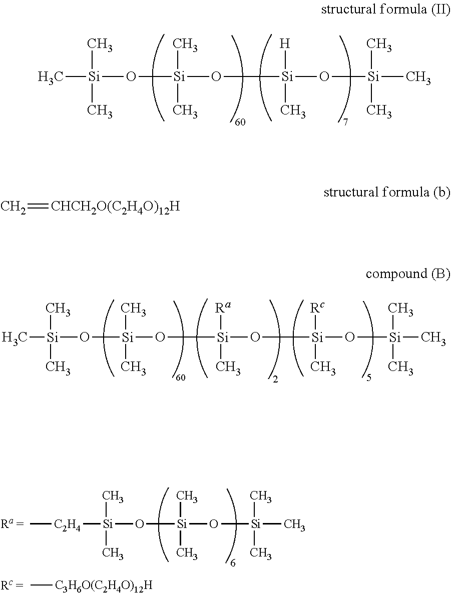

The obtained compound (B) had a value of 5.7 in the expression (I), a value of 0 in the expression (II), and a weight-average molecular weight of 9,200.

### Synthesis Example 3

A compound (C) of the following formula was obtained in a yield of 95% as in Synthesis Example 1, except that 250 g of organohydrogensiloxane shown by the following structural formula (III) was used instead of one in the structural formula (I) in Synthesis Example 1, the addition amount of organosiloxane of the structural formula (i) was changed to 41 g, and polyoxyalkylene compound of the structural formula (c) was used in place of one in the structural formula (a) and added in an amount of 335 g.

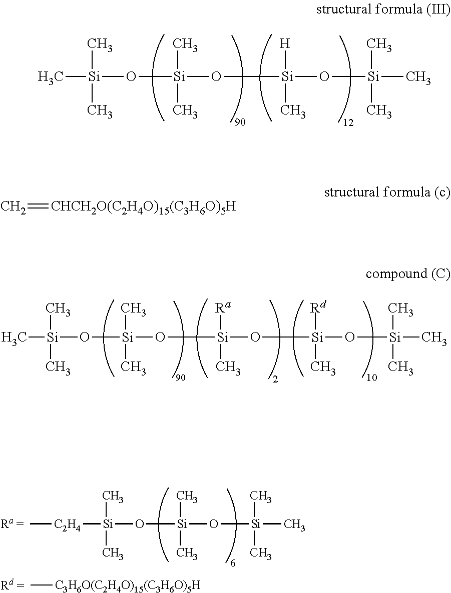

The obtained compound (C) had a value of 7.0 in the expression (I), a value of 0.44 in the expression (II), and a weight-average molecular weight of 18,800.

### Synthesis Example 4

A compound (F) of the following formula was obtained in a yield of 95% as in Synthesis Example 3, except that 269 g of polyoxyalkylene compound of the structural formula (d) was used in place of one in the structural formula (c) in Synthesis Example 3.

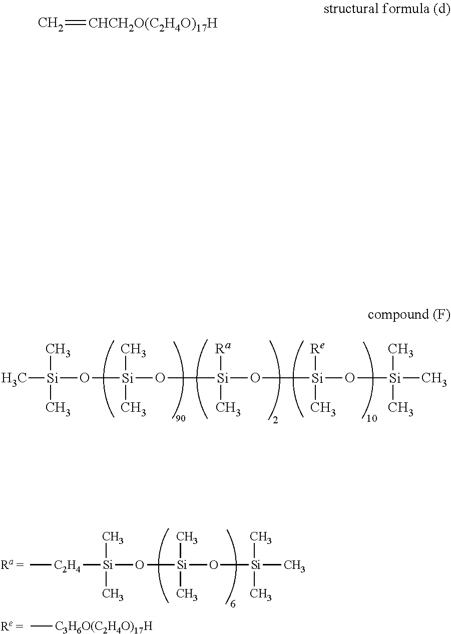

The obtained compound (F) had a value of 8.9 in the expression (I), a value of 0 in the expression (II), and a weight-average molecular weight of 16,800.

### Example 1

A mixture was prepared by mixing 116 g of Bayhydrol A 2651 (aqueous dispersion of 41% acrylic resin manufactured by Covestro AG), 4.65 g of water, 23.3 g of Bayhydur XP 2655 (isocyanate-based curing agent for aqueous system, manufactured by Covestro AG), and 4.00 g of dipropylene glycol methyl ether. To 20 g of this mixture, 0.8 g of 25% dipropylene glycol methyl ether solution of the compound (A) obtained in Synthesis Example 1 was added as the additive for water-based paint. Then, the resultant was mixed by using a dispersion mixer until uniform to prepare a water-based paint composition. After being left standing for 30 minutes, the obtained water-based paint composition was coated on glass using an applicator so as to have the thickness of 30 μm, and heated and cured at 80° C.; for 90 minutes to form a coating layer (1). The obtained coating layer (1) was subjected to various evaluations as follows.

### Compatibility

The water-based paint composition was uniformly mixed by using a dispersion mixer and left standing for 10 minutes. Then, the state of the water-based paint composition was observed.
◯: transparent.
Δ: slightly cloudy.
x: cloudy or separated.

### Defoaming Property

The water-based paint composition was uniformly mixed by using a dispersion mixer and left standing for 10 minutes. Then, the state of the water-based paint composition was observed.
◯: no foams.
Δ: a few fine foams.
x: a lot of foams.

### Leveling Property

The surface state of the coating layer on the glass was visually observed.
◯: smooth surface state.
Δ: fine craters in places on surface.
x: large craters and waves on surface.

### Antifouling Property

A line was drawn with a marker pen on the coating layer on the glass, and rubbed with tissue paper. The easiness for erasing the line was evaluated in this event.
◯: the line was easily erased.
Δ: the line was erased by repeatedly rubbing the layer with force.
x: the line was not erased.

### Example 2

A coating layer (2) was formed and the various properties thereof were evaluated as in Example 1, except that 25% dipropylene glycol methyl ether solution of the compound (B) was used instead of 25% dipropylene glycol methyl ether solution of the compound (A) in Example 1.

### Example 3

A coating layer (3) was formed and the various properties thereof were evaluated as in Example 1, except that 25% dipropylene glycol methyl ether solution of the compound (C) was used instead of 25% dipropylene glycol methyl ether solution of the compound (A) in Example 1.

### Example 4

A coating layer (4) was formed and the various properties thereof were evaluated as in Example 1, except that 25% dipropylene glycol methyl ether solution of the compound (F) was used instead of 25% dipropylene glycol methyl ether solution of the compound (A) in Example 1.

### Comparative Example 1

A coating layer (5) was formed and the various properties thereof were evaluated as in Example 1, except that 25% dipropylene glycol methyl ether solution of the compound (A) in Example 1 was not added.

### Comparative Example 2

A coating layer (6) was formed and the various properties thereof were evaluated as in Example 1, except that 25% dipropylene glycol methyl ether solution of a compound (D) of the following formula (the value in the expression (I): 3.9, the value in the expression (II): 0, weight-average molecular weight: 6,100) was used instead of 25% dipropylene glycol methyl ether solution of the compound (A) in Example 1.

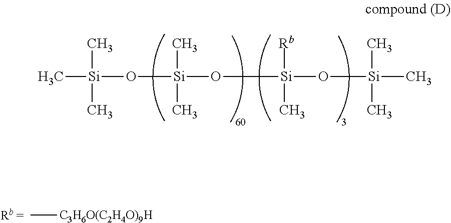

### Comparative Example 3

A coating layer (7) was formed and the various properties thereof were evaluated as in Example 1, except that 25% dipropylene glycol methyl ether solution of a compound (E) of the following formula (the value in the expression (I): 4.7, the value in the expression (II): 0, weight-average molecular weight: 6,100) was used instead of 25% dipropylene glycol methyl ether solution of the compound (A) in Example 1.

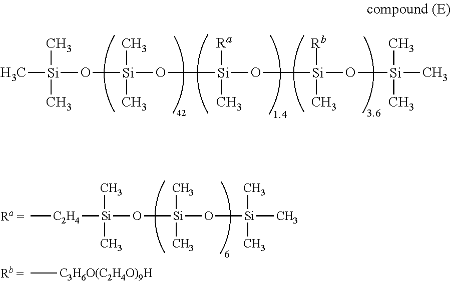

### Comparative Example 4

A coating layer (8) was formed and the various properties thereof were evaluated as in Example 1, except that 25% dipropylene glycol methyl ether solution of a compound (G) of the following formula (the value in the expression (I): 10.1, the value in the expression (II): 0, weight-average molecular weight: 17,100) was used instead of 25% dipropylene glycol methyl ether solution of the compound (A) in Example 1.

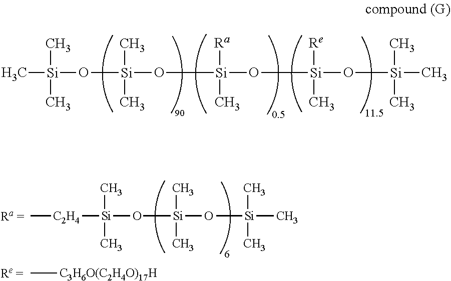

### Comparative Example 5

A coating layer (9) was formed and the various properties thereof were evaluated as in Example 1, except that 25% dipropylene glycol methyl ether solution of a compound (H) of the following formula (the value in the expression (I): 5.2, the value in the expression (II): 1.10, weight-average molecular weight: 20,400) was used instead of 25% dipropylene glycol methyl ether solution of the compound (A) in Example 1.

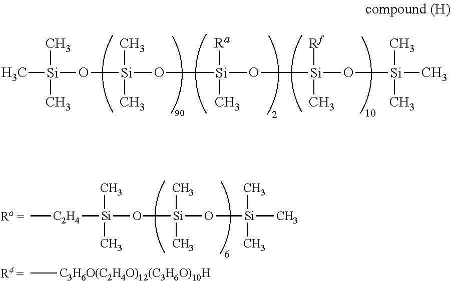

The following Table 1 shows the results of Examples 1, 2, 3, and 4 and Comparative Examples 1, 2, 3, 4, and 5.

TABLE 1

| | | | | | Comparative | Comparative | Comparative | Comparative | Comparative |
|---|---|---|---|---|---|---|---|---|---|
| | Example 1 | Example 2 | Example 3 | Example 4 | Example 1 | Example 2 | Example 3 | Example 4 | Example 5 |
| Coating layer | (1) | (2) | (3) | (4) | (5) | (6) | (7) | (8) | (9) |
| Compatibility | ◯ | ◯ | ◯ | ◯ | ◯ | X | X | ◯ | Δ |
| Defoaming | ◯ | ◯ | ◯ | ◯ | Δ | ◯ | ◯ | Δ | ◯ |
| Property | | | | | | | | | |
| Leveling | ◯ | ◯ | ◯ | ◯ | X | X | Δ | ◯ | Δ |
| Property | | | | | | | | | |
| Anti-fouling | ◯ | ◯ | ◯ | ◯ | X | X | Δ | X | X |
| Property | | | | | | | | | |

As shown in Table 1, it was revealed that the coating layers (1), (2), (3), and (4) formed from the water-based paint compositions using the inventive additives for water-based paint exhibited excellent antifouling property without impairing compatibility, defoaming property, and leveling property.

In contrast, Comparative Example 1 using the water-based paint composition without the additive failed to obtain good results in any of defoaming property, leveling property and antifouling property. Unlike the inventive additives for water-based paint, since the additive used in Comparative Example 2 did not have the structure of the general formula (4), good antifouling property was not obtained, either; besides, since the value in the expression (I) was not more than the lower limit value, the compatibility was also poor. In Comparative Example 3, although the additive having the structure of the general formula (4) was used, the value in the expression (I) was not more than the lower limit value, so that the compatibility was poor, and the result of the antifouling property was also inferior to the present invention. Meanwhile, Comparative Example 4 exceeded the upper limit of the expression (I), so that the antifouling property was lower. Further, Comparative Example 5 exceeded the upper limit of the expression (II), so that decreases in compatibility, leveling property, and antifouling property were observed.

It should be noted that the present invention is not limited to the above-described embodiments. The embodiments are just examples, and any embodiments that substantially have the same feature and demonstrate the same functions and effects as those in the technical concept disclosed in claims of the present invention are included in the technical scope of the present invention.

1. An additive for water-based paint, comprising a siloxane-branched polyether-modified silicone shown by an average composition formula (1) R¹ₐR²_{b}R³_{c}SiO_{(4-a-b-c)/2} and having a weight-average molecular weight in a range of 500 to 100,000,
wherein in the formula (1) each R¹ is identical to or different from one another and represents an organic group selected from an alkyl group, an aryl group, and an aralkyl group having 1 to 30 carbon atoms, and an organic group shown by a general formula (2) —CₘH₂ₘ—O—(C₂H₄O)_{d}(C₃H₆O)ₑR⁴;
each R² represents a group shown by a general formula (3) —CₘH₂ₘ—O—(C₂H₄O)_{f}(C₃H₆O)_{g}—R⁵;
each R³ represents an organosiloxane shown by the following general formula (4) 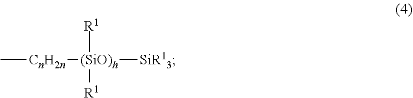
R⁴ represents a hydrocarbon group having 4 to 30 carbon atoms, or an organic group shown by R⁶—(CO)—;
R⁵ represents a hydrogen atom, a hydrocarbon group having 1 to 30 carbon atoms, or an organic group shown by R⁶—(CO)—;
R⁶ represents a hydrocarbon group having 1 to 30 carbon atoms;
R¹ in the general formula (4) is the same as R¹ in the formula (1);
“a”, “b”, and “c” respectively satisfy 1.0≤a≤2.5, 0.001≤b≤1.5, and 0.001≤c≤1.5;
“d” and “e” respectively represent integers satisfying 0≤d≤50 and 0≤e≤50;
“f” and “g” respectively represent integers satisfying 2≤f≤200, 0≤g≤200, and f+g being 3 to 200;
“m” represents an integer satisfying 0≤m≤10;
“h” represents an integer satisfying 0≤h≤500; and
“n” represents an integer satisfying 1≤n≤5, and wherein the siloxane-branched polyether-modified silicone satisfies the following expression (I) and the following expression (II),
5≤{(a total molecular weight of a (C₂H₄O)_{d} part in the general formula (2) and a (C₂H₄O)_{f} part in the general formula (3) incorporated in the siloxane-branched polyether-modified silicone)/(a molecular weight of the siloxane-branched polyether-modified silicone)}×20≤10, and expression (I):
{(a total molecular weight of a (C₃H₆O)ₑ part in the general formula (2) and a (C₃H₆O)_{g} part in the general formula (3) incorporated in the siloxane-branched polyether-modified silicone)/(a total molecular weight of a (C₂H₄O)_{d} part in the general formula (2) and a (C₂H₄O)_{f} part in the general formula (3) incorporated in the siloxane-branched polyether-modified silicone)}1.0. expression (II)

2. The additive for water-based paint according to claim 1, further comprising a solvent.

3. A water-based paint composition comprising the additive for water-based paint according to claim 1 or 2.

4. The water-based paint composition according to claim 3, comprising a resin selected from the group consisting of urethane resins, acrylic resins, amide resins, phenolic resins, epoxy resins, melamine resins, urea resins, alkyd resins, polyimide resins, polyalkylene resins, polyvinyl chloride, polystyrene, polyvinyl acetate, and alloys of the resins.

5. The water-based paint composition according to claim 4, wherein the resin is a urethane resin or an acrylic resin.

6. The water-based paint composition according to any one of claims 3 to 5, the composition being used for antifouling paint.

7. A coating layer formed from the water-based paint composition according to any one of claims 3 to 6.
